(19) United States
(12) Patent Application Publication
(10) Pub. No.: US 2021/0320784 A1
(43) Pub. Date: Oct. 14, 2021

(54) Blockchain-based NRC Community System

(71) Applicant: Zhi Yan, Beijing (CN)

(72) Inventor: Zhi Yan, Beijing (CN)

(21) Appl. No.: 16/843,963

(22) Filed: Apr. 9, 2020

(51) Int. Cl. H04L 9/06; G06Q 20/06

(52) U.S. Cl. CPC H04L 9/0637; H04L 2209/56; H04L 2209/38; G06Q 20/065

(57) ABSTRACT

This invention refers to a blockchain-based NRC community system, which includes real-name user system, equity issuing system, distributed ledger system and system maintenance behavior. The real-name user system consists of equity members, the union constituted by equity members, and union's administrator; and the equity issuing system is composed of issuing organization, equity certificate and task book. Equity members can be upgraded to union's administrator by obtaining a certain quantity of equity certificates, and the administrator is responsible for subdividing community construction tasks in task book, which is comprised of a definite quantity of equity certificates and open to all equity members. The equity certificates received by equity members upon completion of task book will be registered by distributed ledger system that is open to all equity members. This invention is superior to existing technologies in following aspects: avoid individual fraudulent conducts concerning quality and pricing of task book; and reach a community consensus on co-building, co-ownership and sharing based on mutual trust.

### TECHNICAL FIELD

This invention refers to a blockchain-based NRC community system in the field of blockchain technology.

### TECHNICAL BACKGROUND

In modern society, people interact with each other. The community mode developed based on territory and human relations constitutes the most basic content of social organism, whereas within the community, there is a lack of reasonable and effective management tools, thus leading to dissymmetry between rights and obligations, frauds between people and organizational loopholes. All these will impair people's creativity and initiative, then causing the failure to develop an organization with a strong sense of cohesion.

Blockchain technology, also known as distributed ledger technology, is a kind of internet database technology, which is characterized by decentration, openness and transparency so that everyone can participate in database recording. Particularly, as a type of data structure saving data in chronological order, blockchain can support consensus mechanism effectively. That is, blockchain's user can trust software system in blockchain protocol to conclude a deal without the need to trust the other trading partner or a centralized organization. When the trust network is built between machines, new credit creation may rely on technical endorsement rather than decentralized credit organization.

The key to addressing community issues is to solve the crisis of confidence between people for the purpose of inspiring creativity and enthusiasm, and then reaching a community consensus of co-building, co-ownership and sharing. Thus, considering the consensus mechanism of blockchain technology, a blockchain-based NRC community system is put forward, with NRC denoting Nova Realm City.

### CONTENTS OF INVENTION

This invention brings forward a blockchain-based NRC community system to overcome the technical defects above.

To tackle the technical problems above, this invention offers the technical scheme below: the blockchain-based NRC community system includes real-name user system, equity issuing system, distributed ledger system and system maintenance. The real-name user system consists of equity members, the union constituted by equity members, and union's administrator; and the equity issuing system is composed of issuing organization, equity certificate and task book. Equity members can be upgraded to union's administrator by obtaining a certain quantity of equity certificates, and the administrator is responsible for subdividing community construction tasks in task book, which is comprised of a definite quantity of equity certificates and open to all equity members. The equity certificates received by equity members upon completion of task book will be registered and confirmed by distributed ledger system that is open to all equity members. System maintenance means technical maintenance of equity issuing system and distributed ledger system.

This invention is superior to existing technologies in following aspects: task book bound with a certain quantity of equity certificates and open to all community members is proposed based on the requirement for community construction. All equity members may supervise task book and the quantity of equity certificates in relation to pricing of task book, which can guarantee that task book provides services for community development and its price is fixed reasonably. Equity members may obtain task book according to their abilities as well as a corresponding number of equity certificates after completion of task book is registered and confirmed by distributed ledger system. In this way, the behaviors of task book-related administrators and equity members will be recorded in distributed ledger system in the form of real name, and such behaviors cannot be altered. Besides, everybody's equity certificates and their transfer will be also recorded and unchangeable. This will avert individual fraudulent conducts in respect of task book's quality and pricing, and help to reach a community consensus based on mutual trust. Such consensus based on mutual supervision and game is developable and able to create a community consensus of co-building, co-ownership and sharing.

Preferably, equity members are real-name users who get trading authorization through blockchain's ledger protocol, and the real-name user system grants authorization relying on blockchain technology.

Preferably, the task book can be proposed by equity members and validated by union's administrator. The transfer of equity certificates between administrator in relation to task book and equity member shall be subject to real-name record of distributed ledger system.

Preferably, the equity certificates are based on blockchain technology and the transfer shall be subject to signature and confirmation of bookkeeper's secrete key.

Preferably, the equity members and the administrator supervise each other, and besides, there is a two-way selection between the equity members and the union.

Preferably, the system maintenance behavior and the maintenance address will be recorded and made public through blockchain.

### ILLUSTRATIONS ON FIGURES

FIG. 1 Schematic Diagram for Blockchain-based NRC Community System of this Utility Model

### SPECIFIC IMPLEMENTATION MODE

Further and detailed explanation on this invention will be made as follows.

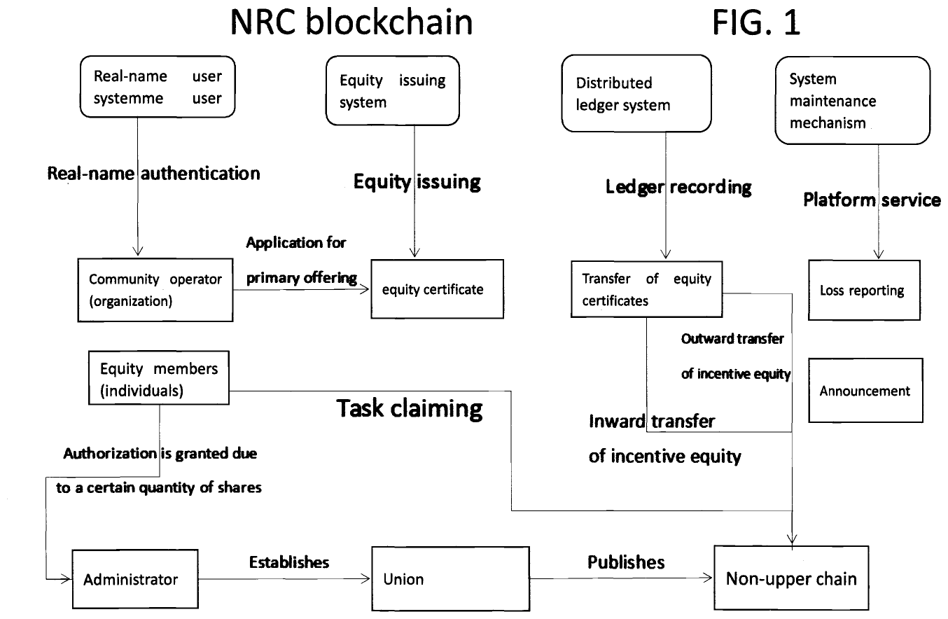

According to FIG. 1, the blockchain-based NRC community system includes real-name user system, equity issuing system, distributed ledger system and system maintenance. The real-name user system consists of equity members, the union constituted by equity members, and union's administrator; and the equity issuing system is composed of issuing organization, equity certificate and task book. Equity members can be upgraded to union's administrator by obtaining a certain quantity of equity certificates. They are real-name users who get trading authorization through blockchain's ledger protocol, and the real-name user system grants authorization relying on blockchain technology. The administrator is responsible for subdividing community construction tasks in task book, which is comprised of a definite quantity of equity certificates and open to all equity members. The task book of the blockchain-based NRC community system can be proposed by equity members and validated by union's administrator. The transfer of equity certificates between administrator in relation to task book and equity member shall be subject to real-name record of distributed ledger system. The equity members and the administrator supervise each other, and besides, there is a two-way selection between the equity members and the union. A certain quantity of equity certificates received by equity members upon completion of task book will be recorded by distributed ledger system that is open to all equity members. System maintenance means technical maintenance of equity issuing system and distributed ledger system. The system maintenance behavior and the maintenance address will be recorded and made public through blockchain. The equity certificates are based on blockchain technology and the transfer shall be subject to signature and confirmation of bookkeeper's secrete key.

During implementation, this invention allows community members to enter different unions as equity members. Several equity members may also build a union independently. Equity members are real-name users who get trading authorization through blockchain's ledger protocol, and the real-name user system grants authorization relying on blockchain technology. Equity members in the union will become union's administrator by obtaining a high number of equity certificates. The task book is proposed according to the requirements for community construction, and the pricing of task book is based on a certain number of equity certificates. The transfer of equity certificates between administrator in relation to task book and equity member shall be subject to real-name record of distributed ledger system. Task book and its corresponding equity certificates are open to all equity members, who may receive task book according to personal abilities and preference. Upon completion, corresponding certificate shall be revealed by task book in illustrated form. Upon confirmation of administrator, equity members will obtain a corresponding number of equity certificates, and such transferring behavior will be recorded by distributed ledger system. The equity certificates registered by distributed ledger system from being issued to being transferred will be unchangeable. This will avert individual fraudulent conducts regarding quality of task book received by equity members as well as utilization of dissymmetric task book and equity certificates.

Once such behavior takes place, the transfer of equity certificates resulting from frauds will be recorded by distributed ledger system, and such record cannot be altered. In this way, the game consensus will be built based on mutual supervision and game, i.e., the three-party game among community, union and equity members. Community construction requires joint efforts from all unions and their equity members who may select to participate in a union which shall acquire community resources for community construction and member service. At the same time, blockchain-based distributed ledger system can avoid frauds and conspiracies to reach a consensus on development, which can encourage all community members to trust each other and foster an atmosphere of co-building, co-ownership and sharing.

All above is a description on this invention and its implementation mode, and such description is not restrictive. On the whole, it is only a satisfying example for patent of this invention, which has no restrictions over such patent. Any modifications, substitutes or improvements within the tenet and principle of this invention's patent shall fall within the protective scope of this invention's patent.

1. The blockchain-based NRC community system is characterized by real-name user system, equity issuing system, distributed ledger system and system maintenance. The real-name user system consists of equity members, the union constituted by equity members, and union's administrator; and the equity issuing system is composed of issuing organization, equity certificate and task book. Equity members can be upgraded to union's administrator by obtaining a certain quantity of equity certificates, and the administrator is responsible for subdividing community construction tasks in task book, which is comprised of a definite quantity of equity certificates and open to all equity members. The equity certificates received by equity members upon completion of task book will be registered and confirmed by distributed ledger system that is open to all equity members. System maintenance means technical maintenance of equity issuing system and distributed ledger system.

2. As described by claim 1, equity members in the blockchain-based NRC community system are real-name users who get trading authorization through blockchain's ledger protocol, and the real-name user system grants authorization relying on blockchain technology.

3. As described by claim 1, the task book of the blockchain-based NRC community system can be proposed by equity members and validated by union's administrator. The transfer of equity certificates between administrator in relation to task book and equity member shall be subject to real-name record of distributed ledger system.

4. As described by claim 1, the equity certificates of the blockchain-based NRC community system are based on blockchain technology and the transfer shall be subject to signature and confirmation of bookkeeper's secrete key.

5. As described by claim 1, the equity members and the administrator of the blockchain-based NRC community system supervise each other, and besides, there is a two-way selection between the equity members and the union.

6. As described by claim 1, the system maintenance behavior of the blockchain-based NRC community system and the maintenance address will be recorded and made public through blockchain.
